(19) United States
(12) Patent Application Publication
(10) Pub. No.: US 2019/0184495 A1
(43) Pub. Date: Jun. 20, 2019

(54) METHOD FOR CONNECTING COMPONENTS BY MEANS OF ADDITIVE MANUFACTURING AND DEVICE

(71) Applicant: Rolls-Royce Deutschland Ltd & Co KG, Blankenfelde-Mahlow (DE)

(72) Inventors: Bjoern ULRICHSOHN, Dresden (DE); Bjoern HINZE, Berlin (DE)

(21) Appl. No.: 16/224,215

(22) Filed: Dec. 18, 2018

(30) Foreign Application Priority Data
Dec. 20, 2017 (DE) 10 2017 223 411.3

(51) Int. Cl. B23K 26/342; B33Y 10/00; B33Y 30/00; F01D 5/02

(52) U.S. Cl. CPC B23K 26/342; B33Y 10/00; B23K 2101/001; F01D 5/02; B33Y 30/00

(57) ABSTRACT

A method for connecting components, including the following steps: providing a first component having at least one connection region, wherein at least the connection region is composed of a metal alloy or comprises a metal alloy; providing at least one second component having a connection region, wherein at least the connection region is composed of a metal alloy or comprises a metal alloy; arranging the connection regions of the first and of the second component adjacent to one another; and connecting the connection regions to one another by means of generative manufacturing, in particular by deposition welding. The invention also relates to a corresponding device.

This application claims priority to German Patent Application DE102017223411.3 filed Dec. 20, 2017, the entirety of which is incorporated by reference herein.

The invention relates to a method for joining components according to Claim 1, and to a device according to Claim 11.

In the aviation engineering sector in particular, there is a demand for extremely high-performance components which should simultaneously have as low a weight as possible. For this purpose, metal alloys with particularly high strength and/or temperature resistance are being developed, in particular nickel-based alloys. Here, there is however the difficulty that particularly high-performance alloys are often not weldable, or are weldable only unsatisfactorily. This applies in particular to alloys with a high gamma prime fraction (y). Positively locking connections are therefore often resorted to for connecting multiple components to one another. For example, two components may be screwed together by means of a bolt and a nut, though this can lead to increased weight.

This problem has particular relevance in the case of blade rings in turbomachines. There, a multiplicity of blade airfoils is generally connected to a ring or a disk. Multiple disks or rings are, in turn, connected to one another. If each of these connections is produced by means of a bolt and a nut, a not inconsiderable part of the weight of the blade ring is attributed to the connections. It is also known for a blade ring to be produced in one piece together with blade airfoils in a casting process. Here, however, complex blade geometries can be realized only with difficulty, and it is not possible to use different materials for the ring or the disk, on the one hand, and the blade airfoils, on the other hand. In particular in the hot environment of a turbine, it may however be necessary to provide different materials. If the components of the blade ring are to be welded to one another, for example by means of friction welding or electron beam welding, some materials and material combinations cannot be used. In particular, high-strength and particularly temperature-stable metal alloys, for example some nickel-based alloys, are not suitable for such welding methods.

In particular in the connection of multiple disks or multiple rings to one another, for example to form a turbine stage or a compressor stage, it has hitherto not been possible to use some particularly advantageous, in particular high-strength and temperature-stable metal alloys, for example some nickel-based alloys, for the disks or rings, and to weld these to one another.

It is the object to provide an improved method for connecting components, in particular a method which makes it possible to connect high-performance materials to one another without considerably increasing the weight, and a device having correspondingly connected components.

The object is achieved by a method for connecting components having the features of Claim 1.

In said method, the following steps are provided: providing a first component having one or more connection regions, wherein at least one connection region is composed of a metal alloy or comprises a metal alloy, in particular a nickel-based alloy; providing one or more second components having in each case at least one connection region, wherein at least the connection region is composed of a metal alloy or comprises a metal alloy, in particular a nickel-based alloy; arranging at least one connection region of the first component adjacent to at least one connection region of a second component; and (in particular cohesively) connecting the adjacent connection regions to one another by means of a generative manufacturing method, in particular by deposition welding. In this way, the components are in particular (non-detachably) joined to one another.

This is based on the realization that some metal alloys (in particular materials with a high gamma prime fraction) cannot be satisfactorily welded by means of friction welding or electron beam welding because, in these processes, an excessive introduction of energy can impair the material structure of the alloys. In particular, fractures or cracks may arise in instances of excessive introduction of energy. Furthermore, the outlay for a testing method with which the load capacity of a connection thus produced is tested is very great.

By contrast, in the case of generative manufacturing methods, in particular in the case of deposition welding, only comparatively very low amounts of energy can be introduced into the material of the components to be connected. It is thus possible, for example, for a cohesive connection of the two components to be built up (in generative fashion) in multiple passes. The material may be applied in a multiplicity of layers. Generative manufacturing methods are also referred to generally as Additive Layer Manufacturing, abbreviated to ALM.

The connection regions may be shaped such that, as a result of the arrangement of the connection regions adjacent to one another, an intermediate space is formed between the connection regions. Here, material can be introduced into the intermediate space by means of the generative manufacturing, in particular the deposition welding. In particular, the intermediate space can be filled (for example completely filled) with material. The intermediate space may be formed by virtue of surfaces, facing toward one another, of the connection regions being spaced apart from one another at least in portions. In particular, it is possible for surfaces, facing toward one another, of the connection regions to run in an inclined or curved manner with respect to one another. By means of the intermediate space, it is thus possible to provide a receptacle for the material that is applied during the generative manufacturing. The receptacle supports the applied material. A base of the receptacle may for example be closed by virtue of the first component and the second component making contact with one another at the base.

In one refinement, the intermediate space is funnel-shaped or trough-shaped. In this way, the intermediate space can particularly effectively receive the material introduced by means of the generative manufacturing.

It is preferable for at least one of the first and the second component to comprise, or be composed of, a nickel alloy, in particular a nickel-based alloy. In particular, all of the components may be composed of one or the same nickel alloy, in particular nickel-based alloy, or comprise such an alloy. The generative manufacturing, in particular the deposition welding, is suitable in particular for so-called superalloys, in particular nickel-based alloys such as for example CMSX-4, Udimet or RR1000. Such alloys have particularly high strength and/or are particularly temperature-resistant. Owing to high gamma prime fractions, electron beam welding, for example, is not possible or not satisfactorily possible.

The first component and the second component may comprise different materials or be composed of different materials. For example, the second component is composed of CMSX-4, Udimet or RR1000, and the first component is composed of a different nickel-based alloy, for example Inconel 718. These material combinations would not be connectable, or would not be satisfactorily connectable, by means of friction welding. The proposed method thus creates the possibility of cohesively connecting entirely new material combinations. The material applied by means of the generative manufacturing method may comprise or be composed of the same metal alloy as the first and/or the second component.

The generative manufacturing may be in particular a laser deposition welding method. This method is particularly highly suitable for the processing of nickel-based alloys, and yields particularly good connections.

The first component may have multiple connection regions. It is furthermore possible for multiple second components to be provided, wherein the connection region of each second component is arranged adjacent to in each case one connection region of the first component such that in each case one intermediate space is formed between the adjacent connection regions, and wherein the respectively adjacent connection regions are connected to one another by means of generative manufacturing, in particular by deposition welding.

In one refinement, the first component constitutes a blade carrier for a turbomachine, or a part of a blade carrier of said type. The blade carrier may for example have the shape of a ring or a disk.

At least one second component is for example a blade airfoil for a turbomachine, a further part of the blade carrier, or a further blade carrier. In this way, the blade airfoil can be mounted particularly securely on the blade carrier, or the parts of the blade carrier or the blade carriers on one another.

The method according to any refinement described herein may be configured for producing an arrangement of multiple blade rings, in particular of a compressor stage, a turbine stage and/or a blade ring for a turbomachine, wherein the first component is provided in the form of a ring or of a disk of a turbomachine, and the at least one second component is provided in the form of a further ring or of a further disk (or a further part thereof) or of a blade, in particular of a compressor blade or of a turbine blade. It is thus possible to produce a particularly robust blade ring or a particularly robust arrangement of multiple blade rings, in particular in the form of a compressor stage or a turbine stage, which may furthermore have a particularly low weight, because additional bolt connections are not required. Since the blade rings may be parts which rotate during the operation of the turbomachine (for example in the form of a gas turbine), a weight saving has a pronounced effect. For example, the blade airfoils are composed of CMSX-4, Udimet or RR1000, and the ring or the disk is composed of the same or a different nickel-based alloy, for example of Inconel 718. Even in the case of a connection of multiple disks or multiple rings to one another, the multiple disks or rings may be composed of CMSX-4, Udimet or RR1000.

The above object is also achieved by means of a device produced or producible by means of the method according to any refinement described herein.

The above object is also achieved by means of a device having the features of Claim 11. According to said claim, the device is in particular produced or producible by means of the method according to any refinement described herein, and comprises a first component with at least one connection region, at least one second component with a connection region, wherein the connection regions of the first and of the second component are each composed of a metal alloy or comprise a metal alloy and are arranged adjacent to one another such that an intermediate space is formed between the connection regions, and wherein the connection regions are connected to one another by at least one seam produced by the generative manufacturing, in particular at least one deposition-weld seam, which at least partially fills the intermediate space.

The seam, in particular the deposition-weld seam, is uniquely identifiable from its characteristic shape and structure, superficially and in cross section.

The device may be in the form of a blade ring for a turbomachine and comprise multiple second components in the form of in each case one blade airfoil. Furthermore, the device may be in the form of a turbine or compressor stage for a turbomachine, wherein the first component is formed in the manner of a ring or a disk for a turbomachine, and at least one second component is formed in the manner of a further ring or a further disk.

With regard to the other possible designs in particular of the first and second component and with regard to the corresponding advantages, reference is made to the above statements relating to the method for connecting the components and for producing the blade ring.

The invention will be discussed in connection with the exemplary embodiments illustrated in the figures. In the figures:

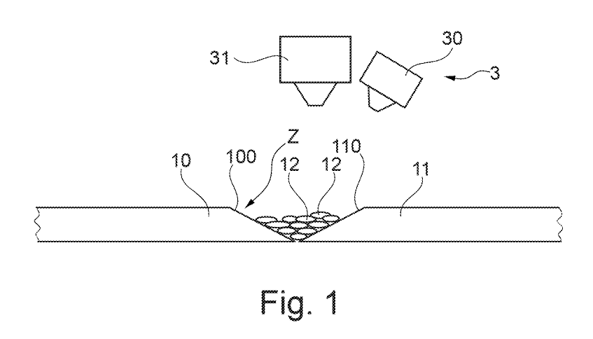

FIG. 1 shows a schematic cross-sectional illustration of connection regions of a first and of a second component connected to one another by deposition-weld seams;

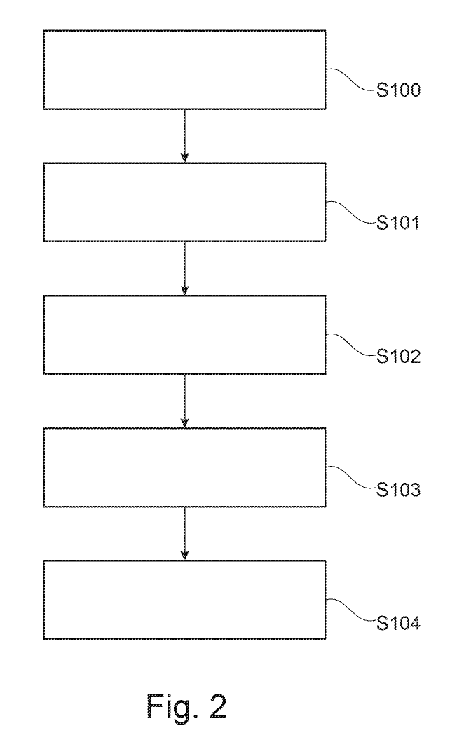

FIG. 2 shows a method for joining components;

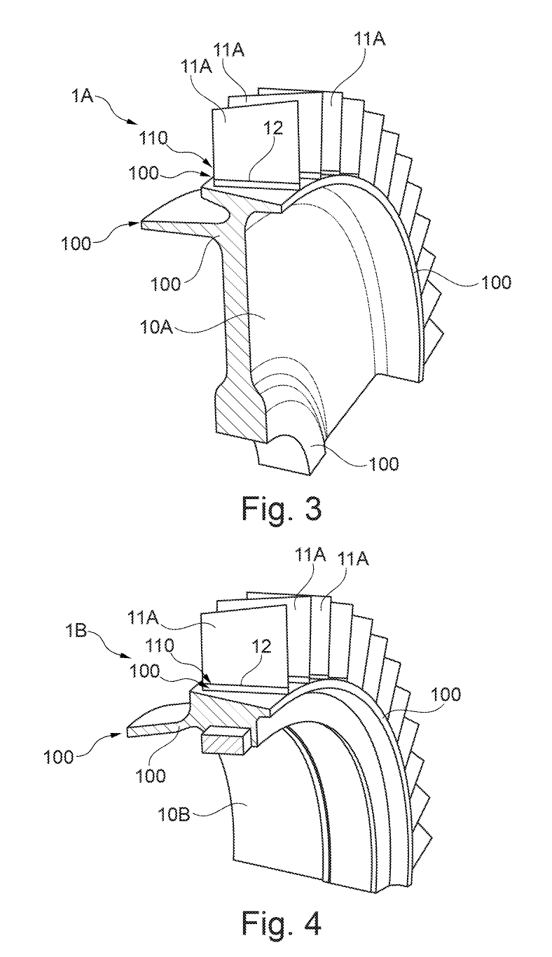

FIG. 3 shows a schematic sectional illustration of a blade ring for a gas turbine having a first component and multiple second components;

FIG. 4 shows a schematic sectional illustration of a further blade ring for a gas turbine having a first component and multiple second components; and

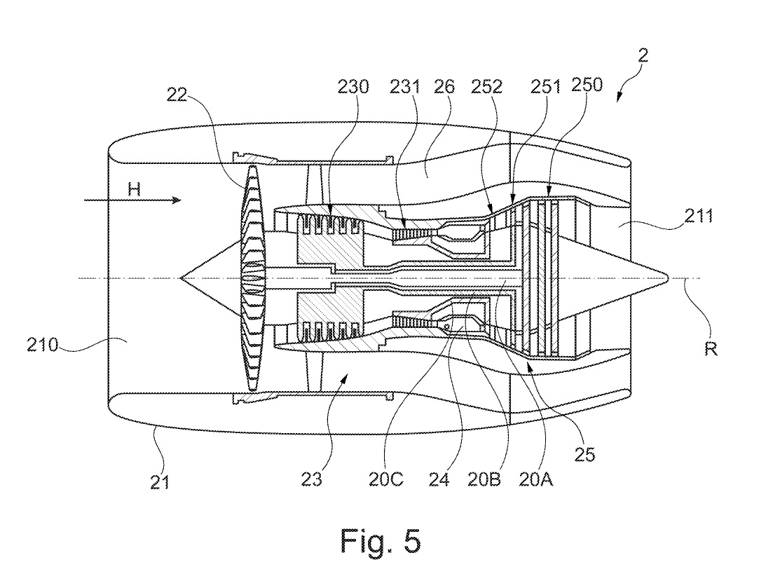

FIG. 5 shows a schematic sectional illustration of a gas turbine having a fan, having a compressor and having a turbine with multiple blade rings.

FIG. 1 shows a first component 10 and a second component 11 connected to one another by means of deposition-weld beads or deposition-weld seams 12.

At least one of the first component 10 and the second component 11 comprises a nickel-based alloy. It is preferable for both components 10, 11 to each be (at least predominantly) composed of the same or of different nickel-based alloys. Example alloys have the designations CMSX-4, Udimet and RR1000. The nickel-based alloy(s) is/are not weldable, or not satisfactorily weldable, by means of friction welding or by means of electron beam welding.

The first component 10 has a connection region 100. In the present case, the connection region 100 is formed in the manner of a surface which slopes obliquely to an end of the first component 10. The second component 11 also has a connection region 110. In the present case, the connection region 110 is also formed in the manner of a surface which slopes obliquely to an end of the second component 11.

The two components 10, 11 are arranged such that the two connection regions 100, 110 face toward one another. The components 10, 11 are arranged adjacent to and so as to adjoin one another, and the components 10, 11 are optionally in contact.

The connection regions 100, 110 of the two components 10, 11 are shaped, and the components 10, 11 are arranged, such that an intermediate space Z is formed between the connection regions 100, 110. In the present case, the intermediate space Z is of triangular or funnel-shaped form in cross section, wherein other shapes are also conceivable. In particular, the intermediate space Z may be trough-shaped. The rest of the shape of the components shown in FIG. 1 is merely exemplary.

Multiple deposition-weld seams 12 have been formed in the intermediate space Z. The deposition-weld seams produce a cohesive connection between the first component 10 and the second component 11. In FIG. 1, the intermediate space Z has been partially filled by the deposition-weld seams 12, specifically by a multiplicity of layers of deposition-weld seams 12. Optionally, the intermediate space Z may also be completely filled, in particular by means of a multiplicity of layers.

The deposition welding is performed by means of a welding device 3. The welding device 3 shown by way of example comprises at least one powder feed means 30 and at least one laser 31. The welding device 3 is designed for laser deposition welding.

The connecting of the components 10, 11 is performed by means of the joining method as per FIG. 2.

According thereto, in a first step S100, the first component 10 is provided. The first component 10 comprises at least the connection region 100, in particular a multiplicity of connection regions 100.

In a second step S101, at least one second component 11 is provided, in particular a multiplicity of second components 11. Each second component 11 comprises at least one connection region 110, for example as shown in FIG. 1. The sequence of the first and second steps is self-evidently not of importance.

In a third step S102, the components 10, 11 are arranged such that their connection regions 100, 110 are arranged adjacent to one another, in particular face toward one another. The connection regions 100, 110 optionally make contact at at least one point. The arrangement of the components 10, 11 is performed such that an intermediate space Z is formed between the adjacently arranged connection regions 100, 110. The intermediate space Z forms a receptacle for receiving deposition-weld material.

In a fourth step S103, the mutually adjacently arranged connection regions 100, 110 are cohesively connected to one another by means of a generative manufacturing method, in the present example by deposition welding, in particular by laser deposition welding. By means of the deposition welding, material is introduced into the intermediate space Z, in particular in the form of elongate beads or seams. The intermediate space Z is partially or completely filled with material by means of the deposition welding. Owing to the receptacle which is for example triangular in cross section, or which generally becomes wider toward the welding device 3, the material can be introduced in a particularly effective, in particular gapless, manner.

For the deposition welding, powder is introduced into the intermediate space Z by means of the powder feed means 30 shown in FIG. 1. The powder is melted by means of laser light of the laser 31 in order to produce a cohesive connection to the connection regions 100, 110 and/or adjacent deposition-weld seams 12. The powder may comprise or be composed of a nickel-based alloy. For example, the powder comprises the same nickel-based alloy as the first and/or the second component 10, 11.

In an optional fifth step S104, a welding aftertreatment is performed, for example by tempering of the device produced from the two interconnected components 10, 11. Alternatively or in addition, the deposition-weld seam 12 is or the deposition-weld seams 12 are ground, for example in order to produce a continuously smooth surface from the first component 10 to the second component 11.

FIGS. 3 and 4 show, in cut-away views, in each case one blade ring 1A, 1B for a turbomachine. The blade rings 1A, 1B are each of symmetrical form about a central axis which, in the installed state in the turbomachine, coincides with a central axis of rotation of the turbomachine.

The blade ring 1A as per FIG. 3 comprises a first component 10A in the form of a (circular or substantially circular) disk. The first component 10A serves as blade carrier. A multiplicity of second components 11A in the form of in each case one blade airfoil is provided on the first component 10A (on the outer circumference thereof). The first component 10A is cohesively connected to each of the second components 11A. The blade ring 1A is a so-called blisk (abbreviation for “blade integrated disk”).

The blade ring 1B as per FIG. 4 comprises a first component 10B in the form of a (circular or substantially circular) ring. The first component 10B serves as blade carrier. A multiplicity of second components 11A in the form of in each case one blade airfoil is provided on the first component 10B (on the outer circumference thereof). An arrangement along the inner circumference of the first component 10B is alternatively also possible. The first component 10B is cohesively connected to each of the second components 11A. The blade ring 1B is a so-called bling (abbreviation for “blade integrated ring”).

Particularly suitable materials for the blade rings 1A, 1B are nickel-based alloys. Nickel-based alloys are often only unsatisfactorily weldable to one another, or not weldable to one another at all, for example by means of friction welding or electron beam welding. Also, the technical demands on the material of the in each case first component 10A, 10B and of the second components 11A may differ from one another, such that one of the two materials is not weldable, or is only unsatisfactorily weldable, by means of friction welding or electron beam welding.

The cohesive connection of the in each case first component 10A, 10B of the blade rings 1A, 1B as per FIG. 3 and FIG. 4 to the respective second components 11A is formed at connection regions 100, 110, facing toward one another, of the first component 10A, 10B and of the second components 11A, in the present case in the root or in the region of the root of the respective second component 11A. The connection is formed by means of one or more deposition-weld seams 12. In particular if the connection region has not been ground, the deposition-weld seams 12 can be identified externally from the typical bead-like deposition-weld seams 12. The deposition-weld seams 12 can also be identified in cross section from their typical shaping and structure. In particular, the deposition-weld seams 12 may have a more coarse-grained material structure than the first and/or the second component 10A, 10B, 11A.

The first components 10A, 10B as per FIGS. 3 and 4 are connected to the second components 11A for example correspondingly to FIG. 1, specifically by means of the method described in conjunction with FIG. 2.

Alternatively or in addition, the first components 10A, 10B of the blade rings 1A, 1B may, as per FIGS. 3 and 4, be produced in multiple parts, wherein the multiple parts (of which then in each case one constitutes a first component and one constitutes a second component, correspondingly to FIG. 1) are cohesively connected to one another in accordance with the method as per FIG. 2, for example at the section faces of the cross-sectional view as per FIGS. 3 and 4, which then serve as connection regions 100. Furthermore, multiple blade rings 1A, 1B may function as first and second components and be cohesively connected to one another, for example so as to be positioned axially one behind the other, in accordance with the method according to FIG. 2. Here, it is for example possible for axial end surfaces of the blade rings 1A, 1B (in particular of the rings or disks of the blade rings 1A, 1B or for the blade rings 1A, 1B) to serve as connection surfaces 100, as illustrated in FIGS. 3 and 4. The connection of the blade rings is then performed for example correspondingly to FIG. 1, in particular in accordance with the method described in conjunction with FIG. 2.

In the present case, the blade rings 1A, 1B as per FIGS. 3 and 4 are, by way of example, illustrated as blade rings for a compressor of a turbomachine (in particular for the gas turbine 2, described below, as per FIG. 5). Correspondingly, it is self-evidently also possible for blade rings for a turbine of a turbomachine (in particular for the gas turbine 2, described below, as per FIG. 5) to be produced by means of a method corresponding to FIG. 2 and designed as described above.

FIG. 5 shows a turbomachine embodied as a gas turbine 2 (in this case as an engine for an aircraft). The gas turbine 2 comprises multiple, in the present case three, shafts 20A, 20B, 20C which are rotatable about a common axis of rotation R. The shafts 20A, 20B, 20C are arranged within a housing 21 of the gas turbine 2. The housing 21 defines an air inlet 210 and an air outlet 211.

An air flow enters the gas turbine 2 through the air inlet 210. The gas turbine 2 has an axial main flow direction H. The main flow direction H runs substantially along the axis of rotation R of the shafts 20A, 20B, 20C. Downstream of the air inlet 210 as viewed in the direction of the main flow direction H, the gas turbine 2 comprises a fan 22, a compressor 23, a combustion chamber 24, a turbine 25 and the air outlet 211.

The gas turbine 2 is, in the present case, of three-stage design. One of the shafts 20A, 20B, 20C serves as low-pressure shaft 20A, one serves as medium-pressure shaft 20B, and one serves as high-pressure shaft 20C. Via the low-pressure shaft 20A, a low-pressure turbine 250 of the turbine 25 drives the fan 22. Via the medium-pressure shaft 20B, a medium-pressure turbine 251 drives a medium-pressure compressor 230 of the compressor 23. Via the high-pressure shaft 20C, a high-pressure turbine 252 of the turbine 25 drives a high-pressure compressor 231 of the compressor 23. The gas turbine 2 thus comprises multiple compressor stages, specifically in particular the medium-pressure compressor 230 and the high-pressure compressor 231. Furthermore, the gas turbine 2 comprises multiple turbine stages, specifically in particular the low-pressure turbine 250, the medium-pressure turbine 251 and the high-pressure turbine 252.

The fan 22 feeds air to a bypass channel 26 for the purposes of generating thrust. The fan 22 and the compressor 23 furthermore compress the air flow entering through the air inlet 210, and conduct said air flow along the main flow direction H into the combustion chamber 24 for the purposes of combustion. Hot combustion gases emerging from the combustion chamber 24 are expanded in the turbine 25 before emerging through a nozzle of the air outlet 211. The nozzle ensures a residual expansion of the emerging hot combustion gases and mixing with secondary air, wherein the emerging air flow is accelerated.

The compressor 23 and the turbine 25 of the gas turbine 2 comprise at least one, in the present example in each case multiple, blade ring(s). Here, in each case multiple rotor blade rings are provided, which rotate together with the respective shaft 20A, 20B, 20C in the housing 21, and multiple guide blade rings, which are arranged so as to be rotationally fixed with respect to the housing 21.

The compressor 23 and/or the turbine 25 comprise(s) a blade ring or multiple blade rings as per FIG. 3 or FIG. 4, or produced by means of the method as per FIG. 2. In this way, the compressor 23 and/or the turbine 25 can be produced from particularly robust materials, and at the same time have a particularly low weight.

### LIST OF REFERENCE SYMBOLS

1A, 1B Blade ring
10, 10A, 10B First component
100 Connection region
11, 11A Second component
110 Connection region
12 Deposition-weld seam
2 Gas turbine (turbomachine)
20A Low-pressure shaft
20B Medium-pressure shaft
20C High-pressure shaft
21 Housing
210 Air inlet
211 Air outlet
22 Fan
23 Compressor
230 Medium-pressure compressor
231 High-pressure compressor
24 Combustion chamber
25 Turbine
250 Low-pressure turbine
251 Medium-pressure turbine
252 High-pressure turbine
26 Bypass channel
3 Welding device
30 Powder feed means
31 Laser
H Main flow direction
R Axis of rotation
Z Intermediate space

1. A method for connecting components, comprising the following steps:
providing a first component having at least one connection region, wherein at least the connection region is composed of a metal alloy or comprises a metal alloy;
providing at least one second component having a connection region, wherein at least the connection region is composed of a metal alloy or comprises a metal alloy;
arranging the connection regions of the first and of the second component adjacent to one another; and
connecting the connection regions to one another by means of generative manufacturing, in particular by deposition welding.

2. The method according to claim 1, wherein the connection regions are shaped such that, as a result of the arrangement of the connection regions adjacent to one another, an intermediate space is formed between the connecting regions, wherein material is introduced into the intermediate space by means of the generative manufacturing, in particular the deposition welding.

3. The method according to claim 2, wherein the intermediate space is funnel-shaped or trough-shaped.

4. The method according to claim 1, wherein at least one of the first and the second component comprises or is composed of a nickel-based alloy.

5. The method according to claim 1, wherein the first component and the second component comprise different materials or are composed of different materials.

6. The method according to claim 1, wherein the generative manufacturing is laser deposition welding.

7. The method according to claim 1, wherein the first component has multiple connection regions, and multiple second components are provided, wherein the connection region of each second component is arranged adjacent to in each case one connection region of the first component such that in each case one intermediate space is formed between the adjacent connection regions, and wherein the respectively adjacent connection regions are connected to one another by deposition welding.

8. The method according to claim 1, wherein the first component is a blade carrier or a part of a blade carrier for a turbomachine.

9. The method according to claim 1, wherein the second component is also a blade carrier or a part of a blade carrier for a turbomachine.

10. The method according to claim 1 for producing a turbine or compressor stage for a turbomachine, wherein the first component is provided in the form of a ring or a disk for a turbomachine, and the at least one second component is provided in the form of a further ring or a further disk.

11. A device, in particular produced by means of the method according to claim 1, comprising a first component with at least one connection region, at least one second component with a connection region, wherein the connection regions of the first and of the second component are each composed of a metal alloy or comprise a metal alloy and are arranged adjacent to one another such that an intermediate space is formed between the connection regions, and wherein the connection regions are connected to one another by at least one seam produced by generative manufacturing, in particular at least one deposition-weld seam, which at least partially fills the intermediate space.

12. A device according to claim 11, wherein the device is in the form of a turbine or compressor stage for a turbomachine, wherein the first component is formed in the manner of a ring or a disk for a turbomachine, and at least one second component is formed in the manner of a further ring or a further disk.
